(19) United States
(12) Patent Application Publication
(10) Pub. No.: US 2023/0272616 A1
(43) Pub. Date: Aug. 31, 2023

(54) CONSTRUCTION FRAME AND SYSTEM COMPRISING AT LEAST ONE CONSTRUCTION FRAME

(71) Applicant: NWT MANAGEMENT GMBH, Taucha (DE)

(72) Inventor: Bruno LAMOUREUX, Bruxelles (BE)

(73) Assignee: NWT MANAGEMENT GMBH, Taucha (DE)

(21) Appl. No.: 18/016,319

(22) PCT Filed: Jul. 15, 2021
(86) PCT No.: PCT/EP2021/069844

§ 371 Date: Jan. 13, 2023

(30) Foreign Application Priority Data
Jul. 16, 2020 (DE) 10 2020 118 807.2

(51) Int. Cl. E04C 2/38

(52) U.S. Cl. CPC E04C 2/384; E04C 2002/001

(57) ABSTRACT

The present invention provides a construction frame comprising a front side, a back side, and a side part, wherein said construction frame further at least one receptacle in the side part. Further, a system comprising at least one construction frame according to the invention is provided. In a preferred embodiment said system comprises at least two construction frames which are connected by at least one connector, which is inserted in the at least one receptacle of each construction frame.

The present invention provides a construction frame comprising a front side, a back side, and a side part, wherein said construction frame further comprise at least one receptacle in the side part. Further, a system comprising at least one construction frame according to the invention is provided. In a preferred embodiment said system comprises at least two construction frames which are connected by at least one connector, which is inserted in the at least one receptacle of each construction frame.

In modern interior design, high demands are laid on flexibility and functionality. This concerns both the room layout and the furnishing of the rooms. The demands on functional office space are just as high as on private living areas or room that requires modularity of construction such as booth exhibitions.

In the best case, rooms should be able to be flexibly partitioned and thus adapted to changing requirements. Mobile partition walls can be used for this purpose. However, these should not only divide the room flexibly but also be flexible in appearance and function.

AU 643254 discloses a wall system for partitioning a relatively large space into smaller spaces. DE 7831509 U1 discloses a wall system for offices with changeable wall panels and DE 10 2008 059 143 A1 discloses a wall system, wherein the height of the wall system is adjustable.

The prior art documents disclose systems, which may be exclusively used as wall systems, especially to divide large spaces into smaller spaces. None of these systems allows a possibility to build up a furniture or other elements for the interior room design. Elements of interior design could be wall cladding, ceiling cladding, floor cladding, walls, a cube etc. The greatest possible flexibility would be offered by a system in which both, wall systems and furniture components can be constructed in a modular fashion. Thereby a great variety of decorative designs, functional elements and accessories should be combinable. Functional elements could be for example lamps, shelfs, screens, power outlets etc. By accessories are meant, for example, vases, plants, pencil holder etc.

Assuming the state of the art it is the purpose of the present invention to provide a system which offers a great variety of elements of interior design, such as, furniture and decoration, combined with high flexibility and various functionalities.

The purpose of the invention is solved by providing a construction frame, construction frame comprising a front side, a back side, and a side part characterized in that the construction frame further comprises
at least four angle pieces;
at least four lateral connector pieces, wherein each lateral connector piece connects at least two angle pieces; and
at least one receptacle in the side part.

The present invention further provides a system comprising at least one construction frame according to the invention.

Furthermore, the use of a constructions frame to build up a system according to the invention is described.

### DETAILED DESCRIPTION

One object of the invention is a construction frame comprising a front side, a back side, and a side part. Accordingly, the construction frame is a 3-dimensional structure which has a cross direction and a longitudinal direction. The longitudinal direction is the direction that extends from the front to the back of the construction frame. The cross direction is the direction perpendicular to the longitudinal direction of the construction frame. In a preferred embodiment, shape and structure of the front side of the construction frame are identical to the shape and structure of the back side of the construction frame.

Further, the construction frame comprises at least four angle pieces and at least four lateral connector pieces, wherein each lateral connector piece connects at least two angle pieces. Preferably, each lateral connector piece connects exactly two angle pieces.

In one embodiment of the invention four lateral connector pieces are connected by four angle pieces, wherein each lateral connector piece connects exactly two angle pieces. Thereby the four lateral connector pieces and the four angle pieces form the front side, the back side and the side part of the construction frame.

In one embodiment each angle piece comprises at least two extensions, wherein each extension can be plugged in a lateral connector piece. Preferably, each extension of an angle piece comprises at least one hole for a screw. In this embodiment each lateral connector piece comprises corresponding holes, so that each angle piece can be plugged in a lateral connector piece and can be fixed by at least one screw. Accordingly, in one embodiment the at least four angle pieces and the at least four lateral connector pieces of the construction frame are detachably connected with each other.

In one embodiment the lateral connector pieces comprise three elongated receiving openings. All three elongated receiving opening are formed over the entire length of the lateral connector piece.

A first elongated receiving opening is positioned on a first side of the lateral connector piece, wherein the first elongated receiving opening extends almost over the entire width of the lateral connector piece. The first elongated receiving opening provides a kind of track in which connecting strips can be pushed in. The connecting strips can preferably slide through the first elongated receiving opening and therefore through the construction frame.

A second and a third elongated receiving opening are provided on a second side of the lateral connector piece, wherein the second side is opposite to the first side. The second and the third elongated receiving openings are each formed as a groove. The two grooves are each located on one of the edges of the second side over the entire length of the lateral connector piece.

Preferably, the first sides of the at least four lateral connector pieces forming a construction frame are all directed to the inside of the construction frame.

As already mentioned, the first elongated receiving opening is suited to receive at least one connecting strip. The at least one connecting trip can be pushed in the first elongated receiving opening and is therefore slidably mounted. The connecting strip comprise in this embodiment an extension at least at one end, preferably at both ends, so that the connecting strip can be pushed in the first elongated receiving opening and can slight inside the first elongated receiving opening. Preferably the connecting strip can be pushed in a first elongated receiving opening of a first lateral connector piece and at the same time in a first elongated receiving opening of a second lateral connector piece, wherein the first and the second lateral connector pieces opposing each other.

The second and the third elongated receiving openings are suited to attach at least one decorative panel. The decorative panel is hooked in either the second or the third elongated receiving opening. In this embodiment the at least one decorative panel comprises an extension, so that the at least one decorative panel can be hooked in the second or the third elongated receiving opening.

In a further embodiment of the invention the at least four angle pieces and the at least four lateral connector pieces form the front side, the back side and the side part of a construction frame, wherein the four angle pieces and the lateral connector pieces are formed in one piece. Accordingly, in this embodiment the angle pieces and the lateral connector pieces cannot be separated from each other. In this embodiment the lateral connector pieces do not comprise any elongated receiving opening. Further, the whole construction frame has one uniform thickness in longitudinal direction.

The construction frame seen from the front side or the back side has an outer geometrical shape that allows several construction frames to be put together. The outer geometrical shape is defined by the side part of the construction frame. Preferably the outer geometrical shape of the construction frame is a polygon, especially preferably a parallelogram. If the geometrical shape is a parallelogram, in one embodiment of the invention the parallelogram is a rectangle, a square or a rhombus. In a preferred embodiment of the invention the outer geometrical shape of the construction frame is a square. In other embodiments of the invention, the outer shape of the construction frame is a multi-sided polygon, such as a triangle, pentagon, hexagon, heptagon or octagon. If the at least four angle pieces and the at least four lateral connector pieces are detachably connected, the lateral connector pieces can be straight or curved. In case the lateral connector pieces are curved, preferably two of the four lateral connector pieces are curved and two of the lateral connector pieces forming the front side, the back side and the side part of a construction frame are straight. With this embodiment a construction frame according to the invention can have a curved front side and back side. In the case the lateral connector pieces are straight, a first and a second lateral connector piece have a first length and a third and a fourth lateral connector piece have a second length. In one embodiment the first and the second length are equal, thus the construction frame is a square. In a further embodiment the first and the second length are not equal, in this case the construction frame can be built having the outer geometrical shape of a rectangle.

The prerequisite in view of the outer shape of the construction frame is that said outer shape enables the building of a system of the invention, which comprises two or more, such as multiple constructions frames, wherein said two or more, such as multiple construction frames are connected to each other at their side parts. In one embodiment and in order to connect several construction frames, the side parts of the construction frames touch each other at least in one point. In a more preferred embodiment, the side parts of the construction frames touch each other over a certain length. In a most preferred embodiment, several construction frames can be put together without gaps.

In one embodiment of the invention the outer geometrical shape of the construction frame is a square with a dimension between 100 mm×100 mm and 1 m×1 m, preferably the dimensions are between 200 mm×200 mm and 500 mm×500 mm, most preferably the square has a dimension of 200 mm×200 mm.

In one embodiment of the invention the outer geometrical shape of the construction frame is a rectangle, the size of which can be scaled depending on the application of the construction frame or a system comprising construction frames.

The construction frame has a certain thickness in longitudinal direction. In one embodiment of the invention the thickness of the construction frame is between 20 mm and 100 mm, preferably between 20 mm and 50 mm, most preferably the construction frame has a thickness of 26 mm. The thickness of the construction frame can be extended according to the needs of a customer.

In case the at least four angle pieces and the at least four lateral connector pieces are detachably connected the thickness in longitudinal direction of the angle pieces is smaller compared to the thickness of the lateral connector pieces in longitudinal direction. According to the invention the two grooves forming the second and the third elongated receiving opening exceed the thickness of the angle pieces on the respective side of the lateral connector piece. Thereby, it is enabled that for example a decorative panel can be hooked or pushed in the second or third elongated receiving opening and can thereby cover the whole construction frame.

According to the invention in one embodiment the construction frame comprises a side part of the construction frame and further an inner structure with a central hole. In one embodiment the inner structure has at least one connection to the side part of the frame. Preferably the inner structure has more than one connection to the side part of the frame.

If the at least four angel pieces and the at least four lateral connector pieces are formed in one piece, the inner structure is formed in one piece as well. Further the inner structure, the at least four angel pieces and the at least four lateral connector pieces are formed in one piece.

If the outer geometrical shape of the construction frame is a polygon, the inner structure has at least one connection to every side of the polygon, preferably the inner structure has exactly one connection to each side of the polygon. Accordingly, if the geometrical shape of the construction frame is a square, in one preferred embodiment the inner structure has exactly one connection to each side of the square. Advantageously the construction frame has a high stability if the inner structure has at least one connection to each side of the polygon.

If the at least four angel pieces and the at least four lateral connector pieces are detachably connected, the inner structure is not formed in one piece. Instead the inner structure comprises at least one connecting piece, preferably the inner structure comprises four connecting pieces. In one embodiment each connecting piece is connected to one angle piece of the construction frame. Preferably, the angle piece comprises in this embodiment a further extension, which can be pushed into a connecting piece and which can be fixed by a suitable hole-screw combination. In a further embodiment each connecting piece can be pushed into the first elongated receiving opening of a lateral connector piece. The inner structure further comprises a central hole, which is formed in one embodiment by a round receptacle. The round receptacle comprises at least one extension which can be pushed into a connector piece. Further, the round receptacle is connected to the at least one connecting piece by at least one screw. Therefore, the round receptacle and the at least one connecting piece comprise suitable holes.

Preferably, the inner structure comprises a central hole which is positioned in the center point of the construction frame. The central hole is a through hole which extends in longitudinal direction through the construction frame. If the outer geometrical shape of the construction frame is a regular polygon the center point of the construction frame is defined as the center of the circumference. If the outer geometrical shape of the construction frame is a rectangle the center point of the construction frame is defined as the point of intersection of the diagonals joining opposite corner points. The person skilled in the art is able to define the center point for other geometrical shapes of the construction frame.

In case the connecting pieces are pushed in the elongated receiving openings of the lateral connector pieces the position of the central hole formed by the round receptacle is fixed if at least two connector pieces connect the round receptacle to two neighbored lateral connector pieces.

In one embodiment of the invention the construction frame further comprises at least one pivot and a receptacle piece, wherein the at least one pivot is inserted in the central hole through the receptacle piece. Therefore, the receptacle piece provides an inner hole which served as recept for a pivot. According to the invention the receptacle piece is inserted in the central hole and the pivot is inserted in the receptacle piece. The pivot and the receptacle piece are fixed by fixing means, such as at least one pair of washer and screw. Preferably the pivot and the receptacle piece are fixed by more than one fixing means, such as more than one pair of washer and screw, preferably by two to four pairs of washer and screw. Any other fixing means, which fulfill the same function as the pairs of washer and screw are also encompassed by the invention. Hence, the pivot protrudes in longitudinal direction from the construction frame. The pivot can serve as a support for functional elements or accessories. The pivot can be hollow or made of solid material. If the pivot is hollow the passage of cables and/or pipes through the pivot is allowed. In one embodiment of the invention the pivot is made of a magnetic material or comprises a magnetic part. This offers additional option to attach accessories and/or functional elements to the pivot. In a further embodiment of the invention the pivot can comprise a clip, wherein the clip is suited to enables attaching an accessory and/or a functional element to the pivot. Suitable clips are known to the persons skilled in the art.

In a further embodiment the pivot inserted in the receptacle piece has a length such that it protrudes from the construction frame on the front and on the back side. In a further embodiment two pivots are connected by the receptacle piece to the construction frame in such a way, that one pivot protrudes from the front side and one pivot protrudes from the backside. In this embodiments the pivot or the pivots can serve as a support for functional elements or accessories on the front side of the construction frame and on the back side of the construction frame.

In a further embodiment of the invention the pivot is inserted in the central hole directly without utilizing a receptacle piece. In this case the central hole is preferably formed by a round receptacle, wherein the round receptacle and the pivot are fixed by more than one fixing means, such as more than one pair of washer and screw, preferably by two to four pairs of washer and screw. Any other fixing means, which fulfill the same function as the pairs of washer and screw are also encompassed by the invention.

In one embodiment the construction frame further comprises one corner through hole in each corner, wherein the corner through holes extend in longitudinal direction of the construction frame. Preferably, each angle piece comprises a corner through hole. Each corner through hole is essentially positioned in each corner of the side part of the construction frame. Preferably the corner through holes are configured to accommodate a pivot. Hence, the corner through hole offers further possibilities, besides the central hole with the receptacle piece to accommodate pivots. Accordingly, additional positions for pivots are provided which can serve as a support for functional elements or accessories.

In a preferred embodiment of the invention the corner through holes, the receptacle and the inner hole of the receptacle piece have the same diameter. This has the advantage that the same type of pivots can be inserted in the corner through holes, the receptacle and the receptacle piece. In one embodiment of the invention the diameter of the through holes, the receptacle and the inner hole of the receptacle piece is between 5 mm and 20 mm preferably between 5 mm and 16 mm.

Accordingly, in a further embodiment of the invention the construction frame according to the invention comprises at least one functional element and/or at least one accessory. In a preferred embodiment of the invention, at least one functional element and/or at least one accessory are attached to the construction frame by a pivot or magnetic pivot or clip pivot which is inserted in a central hole directly, in a receptacle piece in the central hole, in a corner through hole, in a receptacle of a connecting strip or in a receptacle. In one embodiment the connecting strip according to the invention comprises a receptacle which is suited to receive a pivot according to the invention. Functional elements can be selected from the group comprising supports for shelfs, lamps, office accessories, plants, displays and power outlets. Accessories can be selected from the group comprising lamps, vases, office accessories such as a penholder or a clock etc.

Furthermore, the construction frame comprises at least one receptacle in the side part. According to the invention, the at least one receptacle is a through hole in the side part of the construction frame, wherein the through hole extends in cross direction of the construction frame. Preferably at least one receptacle is located at the point in the side part where the inner structure adjoints the side part. In a most preferred embodiment of the invention at least one receptacle is positioned at every point in the side part where the inner structure adjoints the side part.

In a preferred embodiment the side part of the construction frame comprises more than one receptacle. If the outer geometrical shape of the construction frame is a polygon, preferably every side part of the polygon comprises at least one receptacle. In one embodiment of the invention, the outer geometrical shape of the construction frame is a square and every side part of the square comprises exactly one receptacle.

The receptacle is adapted to accommodate a suited connector, a connecting strip or a pivot. The pivot can serve as a support for functional elements or accessories. A suited connector is appropriate to connect a first construction frame with a second construction frame. Thereby, the connector is attached to the connector frame with at least one fixing means, such as a screw. In a preferred embodiment of the invention the connector is attached to the construction frame with two fixing means, such as two screws. A connecting strip can be used to add additional function to the construction frame. As already described the connecting strip according to the invention can comprises a receptacle which is suited to receive a pivot according to the invention. The connecting strip which is suited to be inserted in a receptacle does not comprise any extension at the ends of the connecting strip. The connecting strip which is inserted in a receptacle is fixed e.g. by at least one screw on the receptacle. It is within the common knowledge of a skilled person to use additionally a washer under certain circumstances. In one embodiment of the invention the connecting strip is fixed by two screws on the receptacle.

In a further embodiment of the invention the geometrical shape of the construction frame is a polygon and every side of the polygon comprises two receptacles. Advantageously, this provides even more stability and more opportunities to position functional elements and/or accessories. In one further embodiment of the invention the geometrical shape of the construction frame is a polygon and every side of the polygon comprises more than two receptacles.

Accordingly, in one embodiment of the invention the construction frame further comprises n screw holes, wherein n is an integer between 1 and 20. The screw holes are through holes which extend in longitudinal direction of the construction frame. In a preferred embodiment of the invention, the side part as well as the inner structure comprise screw holes. In one embodiment of the invention one screw hole is located in each corner of the side part. Additionally, one screw hole is located at every point in the inner structure where the inner structure adjoints a side part. Moreover, the screw holes in the inner structure are located in such a manner that they are suited to fix a pivot or a connector in a receptacle of the construction frame.

In a further embodiment at least one screw hole can serve for attaching the construction element for example to a wall, a floor or a ceiling. This can be done with an appropriate mounting system, which could comprise e.g. a locking pin and a locking device or other fixing means, such as screws or the like. Advantageously, no further hole in the construction frame or extensive construction is necessary to attach the construction element. Accordingly, in one embodiment of the invention the construction frame further comprises a mounting system.

In one embodiment of the invention the construction frame further comprises at least one stand and/or at least one caster. The stand and/or the caster are preferably attached to the construction frame through a receptacle or through a receptacle piece. Therefore, the stand and/or the caster are constructed in the appropriate manner. In one embodiment the stand is height-adjustable.

In one embodiment of the invention the construction further comprises at least one cable and/or at least one pipe, wherein the at least one cable and/or at least one pipe advantageously enter the construction frame through a receptacle located in the side part of the construction frame. Due to the inventive structure of the construction frame they are routed through the construction frame. Furthermore, they can be routed to the central hole of the construction frame or to a further receptacle of the construction frame.

In one embodiment of the invention the at least one cable and/or at least one pipe is routed to the central hole and a receptacle piece is provided which is inserted in the central hole and which serves as an outlet for the at least one cable and/or at least one pipe. In this embodiment the receptacle piece is fixed to the construction frame by at least one fixing means, such as a pair of washer and screw. With this embodiment it is possible to include an outlet for electricity, liquids or gases in the construction frame and/or to feed these media inside the construction frame.

The construction frame according to the invention comprises a material selected from the group containing aluminum and ABS plastic with fiber composite. In one preferred embodiment of the invention the construction frame is made of aluminum. In a most preferred embodiment, the construction frame is made of aluminum, such as extruded or injection molded aluminum. In a further embodiment of the invention the lateral connector pieces and/or the connecting strips are aluminum profiles. Preferably the material of which the frame is made is adapted to the field of application of the construction frame. If the construction frame is used in outdoor area the material should preferably resist all environmental influences.

In one embodiment of the invention the construction frame further comprises at least one magnetic part. In one embodiment of the invention, the construction frame as a whole is made of a magnetic material. In a further embodiment at least one metal part is attached to the construction frame, preferably the metal part is attached to the corners of the side part of the construction frame. Suitable magnetic parts are for example magnetic plates or magnetic tape or magnetics connectors.

In a further embodiment of the invention the construction frame comprises at least one decorative panel. The at least one decorative panel can be attached to the front side or the back side of the construction frame by a magnetic coupling or via fixing means, such as screws or clips, glued or a magnetics stitch glued. The decorative panel comprises the corresponding elements to be attached in one of the ways mentioned, i.e. the decorative panel comprises a magnetic part and/or screw holes and/or clips. In a further embodiment the decorative panel is attached to the construction frame by hooking or pushing the decorative panel in the second or the third elongated receiving opening of a lateral connector piece. Alternatively, the decorative panel can be pushed in the second or third elongated receiving opening of a first lateral connector piece and at the same time in the second or third elongated receiving opening of a second lateral connector piece, wherein the first and the second lateral connector pieces are opposing each other. In this embodiment the decorative panel comprises an extension which enables that the decorative panel is hooked or pushed in the second or third elongated receiving opening.

The decorative panel is preferably of the same size and geometrical shape as the construction frame. By attaching the decorative panel to one side of the construction frame, this whole side of the construction frame is covered by the decorative panel. In one embodiment of the invention the construction frame comprises two decorative panels, wherein a first decorative panel is attached to the front side of the construction frame and a second decorative panel is attached to the back side of the construction frame. Furthermore, the decorative panel may comprise at least one perforation, wherein the at least one perforation is located vis a vis a corner through hole, vis a vis a central hole or vis a vis a receptacle piece. The perforation is preferably suited to be an outlet for a pivot or is suited to be used to attach a functional element or an accessory with a central hole, a receptacle piece or a corner through hole. The decorative panel can comprise or consist of a material selected from the group comprising plastics, metals, fabrics, woods, cork, sheets of stone, stabilized plants, white boards, black boards, mirrors. Furthermore, the decorative panel can have any decor desired by a customer, e.g. marble decor, prints, stone decors, color decors, pattern decors and the like. In one embodiment of the invention the decorative panel has a thickness between 2 mm and 10 mm, preferably between 3 mm and 8 mm, most preferably between 3 mm and 5 mm.

Furthermore, the invention provides a system comprising at least one construction frame according to the invention. Accordingly, the system may comprise a construction frame comprising at least one decorative panel and at least one functional element and/or accessory. Further the system comprising one construction frame may comprise all or some of the features described for the construction frame.

In one preferred embodiment of the invention the system comprises at least two construction frames according to the invention, characterized in that said at least two construction frames are connected by at least one connector which is inserted in the at least one receptacle of each construction frame.

All features described for the construction frame are also applicable to the system and vice versa.

In one embodiment the system comprises at least two construction frames which are connected by at least one connector which is inserted in the at least one receptacle of each construction frame. The construction frames comprised in the system have preferably the same size and the same outer geometrical shape. In one embodiment of the invention the connector is selected from the group comprising straight connectors, angle connectors, 90° connectors, 45° connectors and hinge connectors.

A straight connector is a connector which comprise no angle and therefore connecting two construction frames straight in cross direction. An angle connector is a connector comprising a certain angle and therefore connecting two construction frames in a way that a defined angle is build between the cross directions of the two construction frames. According to the invention an angle connector comprises two straight sections, which enclose an angle α. An angle connector according to the invention can comprise any defined angle β, wherein angle R is the supplementary angle to angle α. Preferably angle R is greater than 0° and less than 90°.

Further, the invention provides a 90° connector and a 45° connector. Accordingly, these connectors comprise an angle R of 90° or an angle R of 45°.

The straight connector, angle connector, 90° connector and 45° connector can be hollow or made of solid material. If the connectors are hollow, advantageously pipes and/or cables can be routed through the connectors from a first construction frame to a second construction frame.

Furthermore, a hinge connector is provided. The hinge connector comprises a hinge, therefore a flexible connection of two construction frames is provided.

The connectors preferably comprise or consist of a material selected from the group comprising metals.

In a preferred embodiment of the invention the system comprises more than two construction frames, wherein all construction frames are interconnected by connectors. In this manner a variety of systems can be build. For example, by connecting several construction frames by straight connectors the system can be a wall. By using straight connectors and angle connectors the system can be a wall, a paravent, a box, or a room divider.

According to the invention the construction frames can be fixed to a wall, the floor and/or the ceiling, thereby the system can be a wall cladding, ceiling cladding, floor covering and the like.

Due to the different connectors the system can also be piece of furniture, e.g. a wall cladding with shelves, an office space with desk, a discussion room or office wall. Accordingly in one embodiment of the invention the system is selected from a group comprising a wall, a box, wall shelf, a wall covering, a ceiling covering, a floor covering and a piece of furniture, like a bench, a table, etc.

Due to the use of hinge connectors, it is possible to connect two parts of a system of the invention in a foldable manner. For example, an office space can be build up, which comprises a backside wall and two side walls, wherein the front side consists of two swiveling wall parts, which are forming doors that can be closed after work and can be opened for working. Such an office space may further comprise a roof made of construction frames of the invention. Accordingly, it is possible to build a closable working space, such as an “office box” with the construction frames, connectors, decorative elements and functional elements as described herein. In one embodiment of the invention an office space is build up by four square walls with a door build by construction frames according to the invention.

A similar system can be build up for outdoor use, for example a garden shed or the like.

In a further embodiment of the invention the system is portable. This is made feasible by the feature that the construction frame can comprise at least one caster. Thereby a wall or a piece of furniture can be build which comprises enough casts to be portable. In a further embodiment the system is a free standing wall, wherein the system comprises at least one stand. Two or more walls, which comprise casts, can also be connected via hinge connectors. As a result, it is possible to create a flexible wall system, where the single wall elements are connected to each other in a foldable or swiveling manner.

In a further embodiment of the invention the system comprises at least one decorative panel. The at least one decorative panel can be attached to the front side or the back side of the construction frame by a magnetic coupling or via screws or via a clip or by pushing or hooking the decorative panel in the second or third elongated receiving opening of at least one lateral connector piece. The decorative panel comprises the corresponding elements to be attached in one of the ways mentioned herein, which means that the decorative panel comprises fixing means such as a magnetic part and/or screw holes and/or clips.

In one embodiment of the invention the construction frame comprises two decorative panels, wherein a first decorative panel is attached to front side of the construction frame and a second decorative panel is attached to the back side of the construction frame.

In one embodiment of the invention the decorative panel attached to the system has the same size as a construction frame of the system. In a further embodiment of the invention the decorative panel is larger than the construction frame of the system, preferably the decorative panel has a size which is suited to cover an integer number of construction elements.

In one embodiment of the invention the decorative panel has a size of between 200 mm×200 mm and 1500 mm×1500 mm, without being limited to this example, since the dimension of the decorative panel can be adjusted to the requirements of a customer.

All features already described for the decorative panels attached to the construction frame also apply for the decorative panels attached to the system. Further, decorative panels comprising different materials and/or different designs can be used to cover a system according to the invention. This has the advantage, that functional surfaces like black boards and white board can be integrated for example in an office wall.

In a further embodiment of the invention the system further comprises at least one functional element and/or at least one accessory. Suitable functional elements and accessories are already described above.

In a further embodiment of the invention the system comprises several construction frames which build up a wall with an opening inside. Inside the opening functional elements e.g. like a shelf and/or accessories can be attached to the system by the receptacles of the construction frames adjacent to the opening.

In a further embodiment of the invention the receptacles of the construction frames adjacent to the opening are utilized to attach at least one additional device to the system which is positioned inside the opening. In one embodiment of the invention the at least one additional device is attached to the system by two opposing receptacles in a way that the device is rotatable. In one embodiment of the invention the device could be a device selected from the group comprising at least one further construction frame, a system of several construction frames, a panel with an axis inside.

If the additional device is a construction frame in one embodiment the construction frame of the additional device has preferably a smaller dimension than the construction frames comprised in the wall. In this case it is possible that the construction frames can rotate inside the opening of the wall.

In a further embodiment of the system the construction frames are connected by connectors, wherein additionally spacers are used. Spacer can be for example a kind of washer which fits to the connectors. In this way an additional space is provided between the individual construction frames of the invention.

In a further embodiment of the invention the system comprises several construction frames which build up a wall with an opening inside, wherein the construction frames are connected by connectors and spacers. The receptacles of the construction frames adjacent to the opening are utilized to attach at least one additional device to the system which is positioned inside the opening. In one embodiment of the invention the additional device is a further construction frame which has the same dimension as the construction frames used for building up the wall. The further device is attached to the system by two opposing receptacles in a way that the device is rotatable.

Due to the use of construction frames, the present invention provides a kind of a flexible modular system. This makes it possible to create an almost infinite number of embodiments of the system according to the invention. For example, it is suitable for use as a cladding, to build up a piece of furniture or a freestanding wall. Advantageously, media such as electricity, gas or liquids can be fed into and routed within the system and are available at desired points in the system. Since the system is suited for indoor as well as for outdoor use, the field of applications is extended even further. The system can be used just as well in the office area, living area, kitchen area or bathroom area as outdoors, for example in the garden. Further, it is suited to build up an interior shop designs with shelfs and sales desk or to design the interior of a restaurant, a museum etc. Furthermore, the construction of a complete exhibition stand is possible.

Since media such as electricity, liquid and gases can be integrated a comprehensive solution for a lot of requirements is provided. For example, light sources can be integrated in a system according to the invention in such a way that an illuminated wall is build up.

A further advantage of the present invention is that the system is demountable and therefore all components can be reused to build up a new system, which can be the same system or a different system. Further, decorative panels, functional elements and/or accessories can be changed very easily, thereby the system can always be adapted to the current requirements of a customer.

Furthermore, the invention relates to the use of the construction frames to build a system of the invention.

In the following the invention is further described by 23 figures and 6 examples.

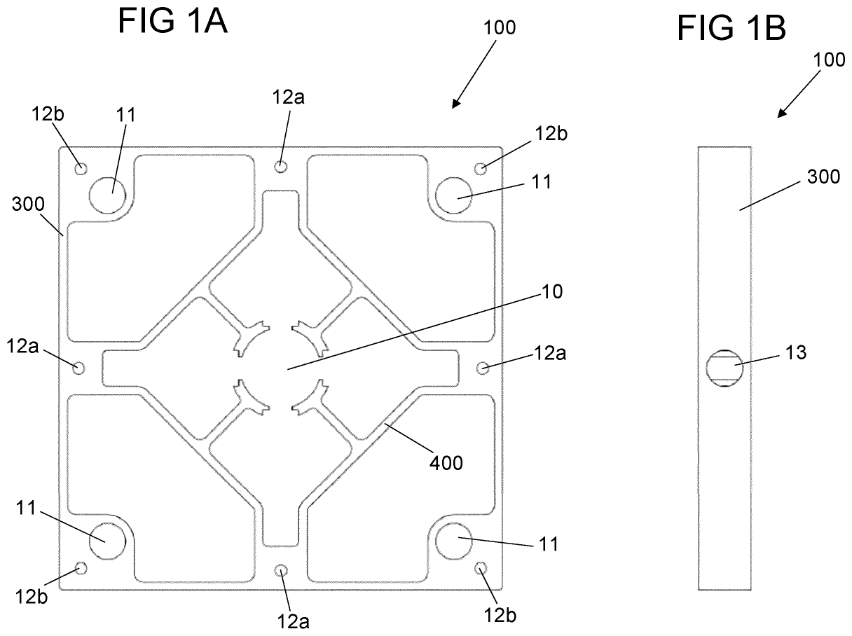

FIG. 1 illustrates an embodiment of the construction frame in cross direction (A) and in longitudinal direction (B);

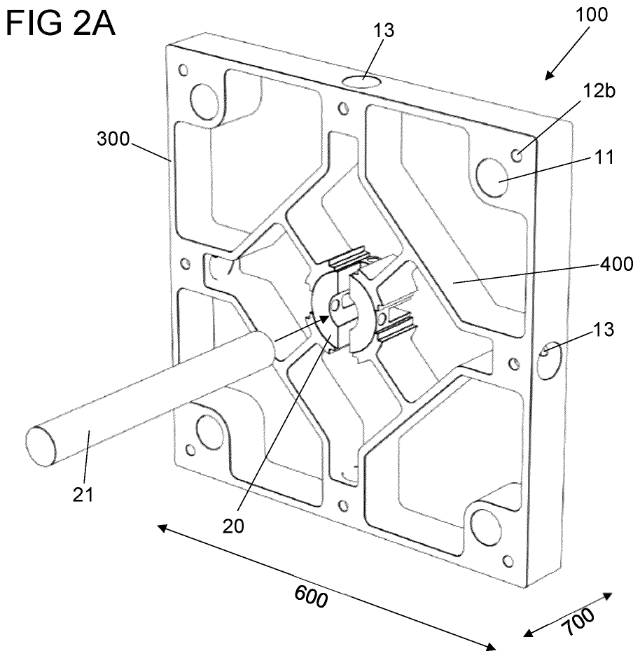

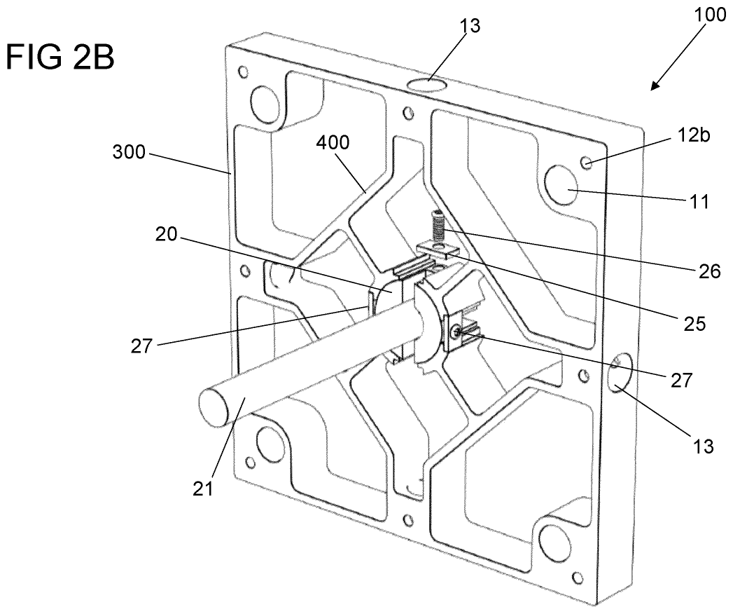

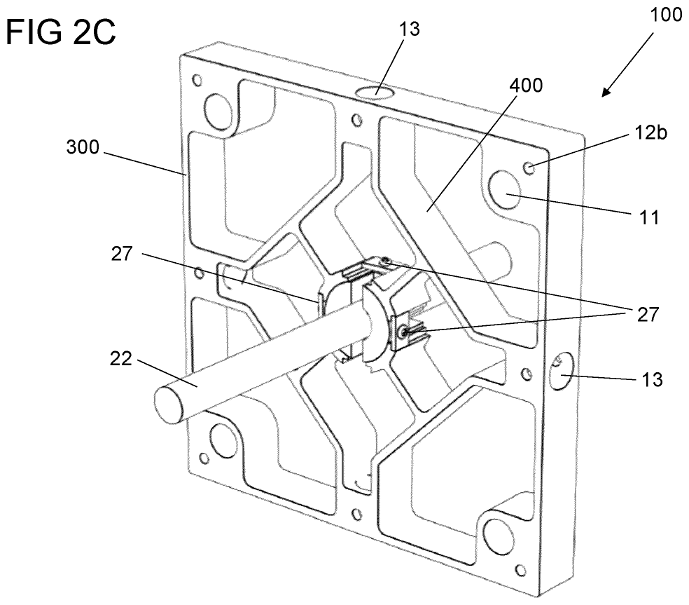

FIGS. 2 (A) to (B) illustrate an embodiment of the construction frame with a receptacle piece and a pivot and (C) a further embodiment of the construction frame with a pivot;

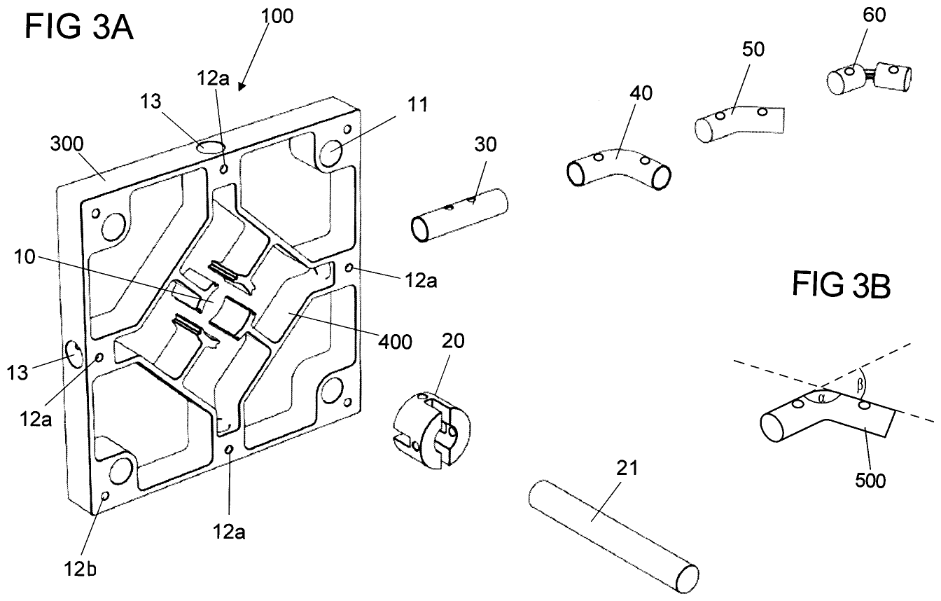

FIG. 3 (A) illustrates an embodiment of the construction frame with a receptacle piece, a pivot and different connectors and (B) illustrates the angle of an angle connector;

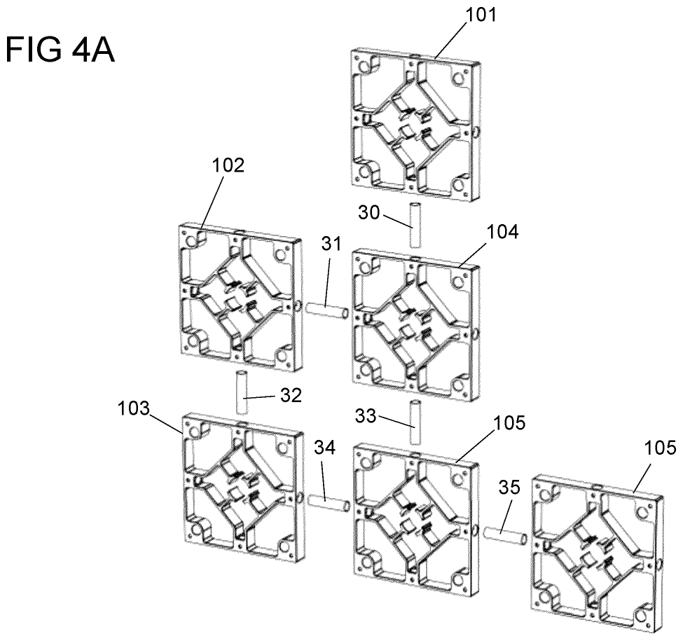

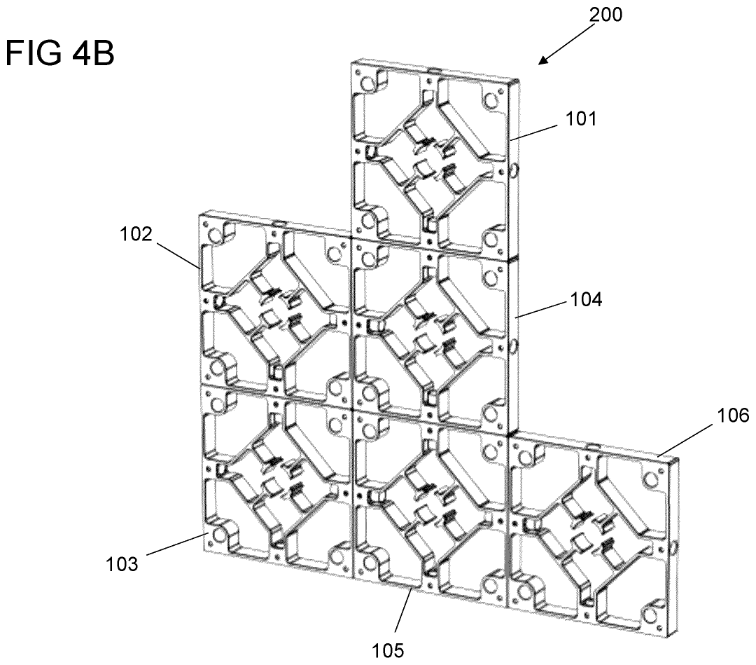

FIGS. 4 (A) and (B) illustrate the connection of several construction frames by straight connectors according to the invention;

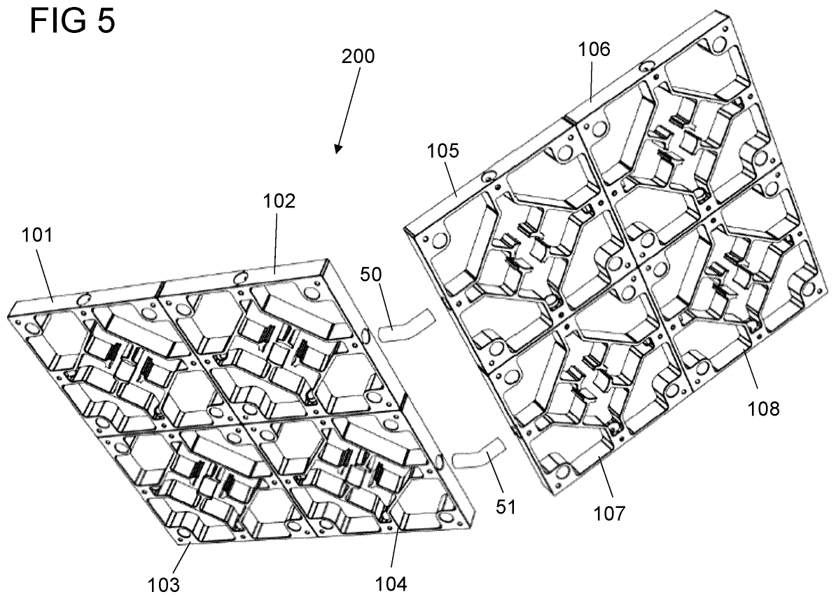

FIG. 5 illustrates the connection of several construction frames by straight connectors and 45° connectors;

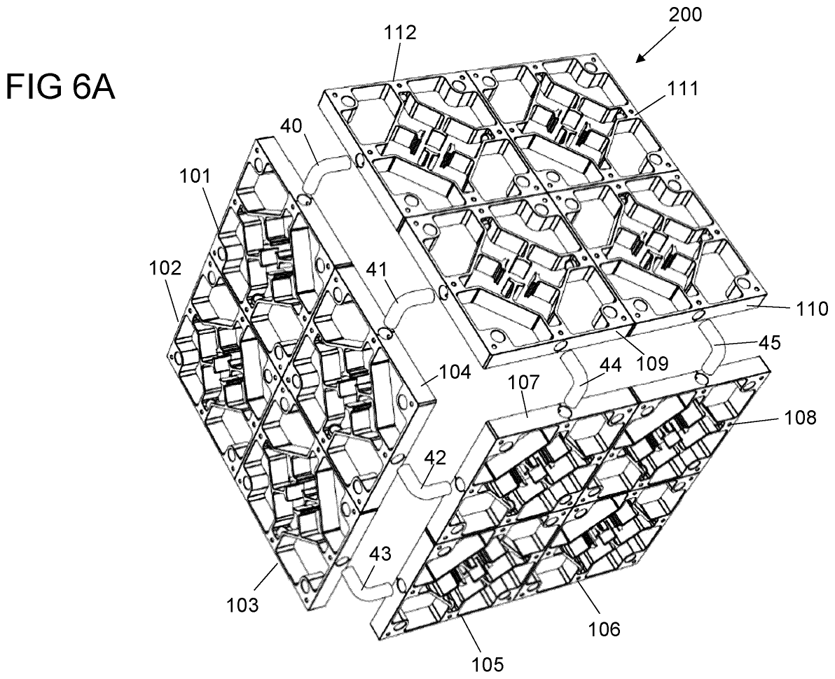

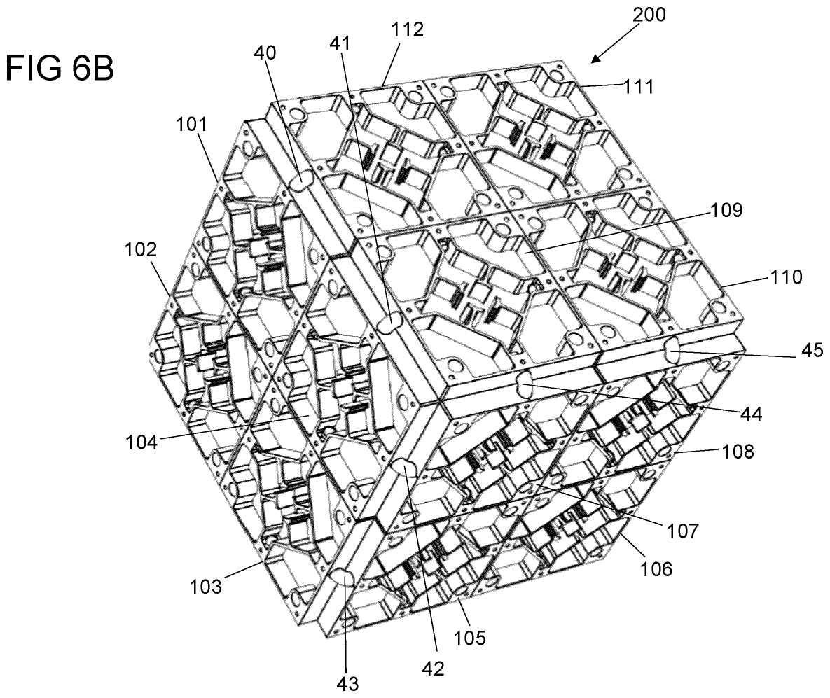

FIGS. 6 (A) and (B) illustrate system which could be a part of a box build up by connecting several construction frames with straight connectors and 90° connectors;

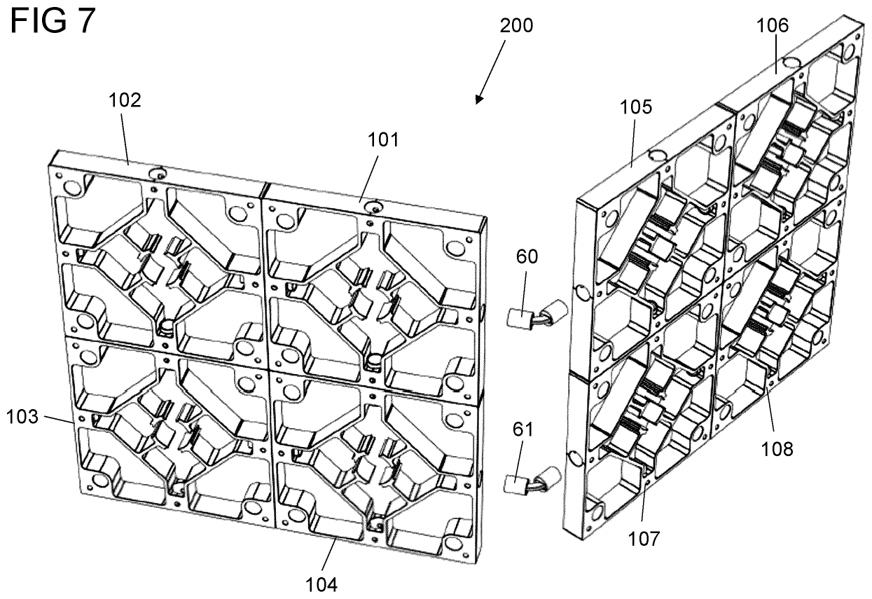

FIG. 7 illustrates the connection of several construction frames by straight connectors and hinge connectors;

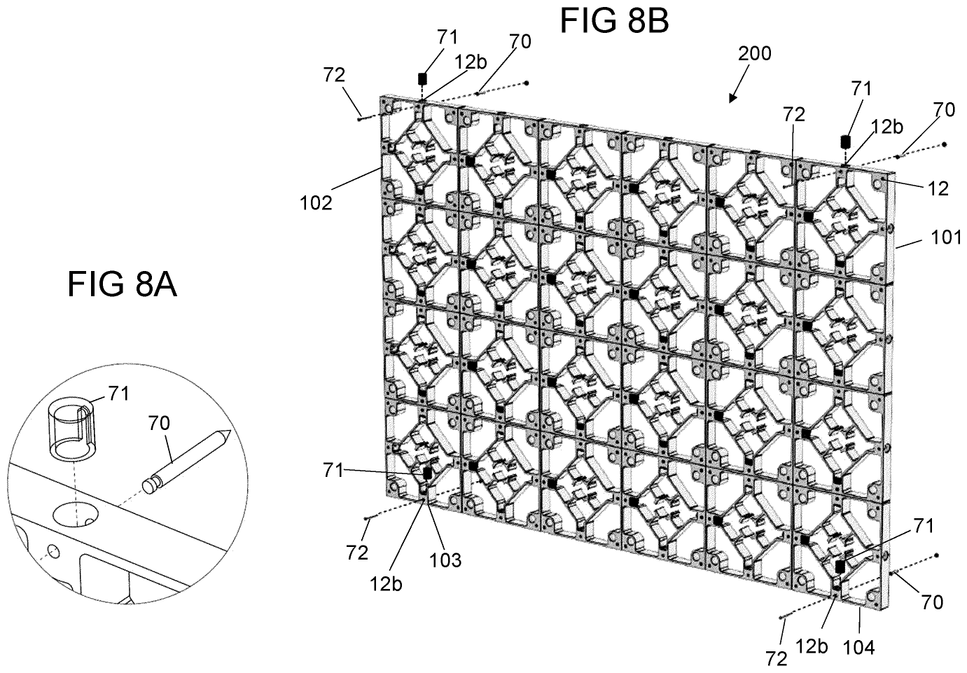

FIG. 8 (A) illustrates an embodiment of the invention with a mounting system and (B) illustrates a system according to the invention which can be fixed with a mounting system;

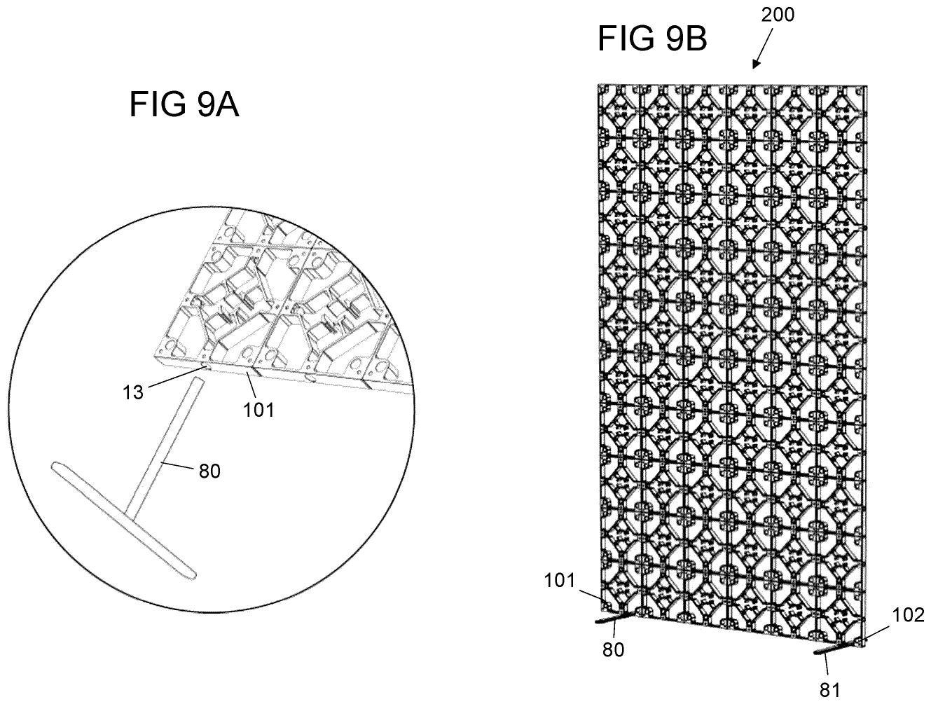

FIG. 9 (A) illustrates a construction frame with a stand and (B) illustrates a freestanding system according to the invention with two stands;

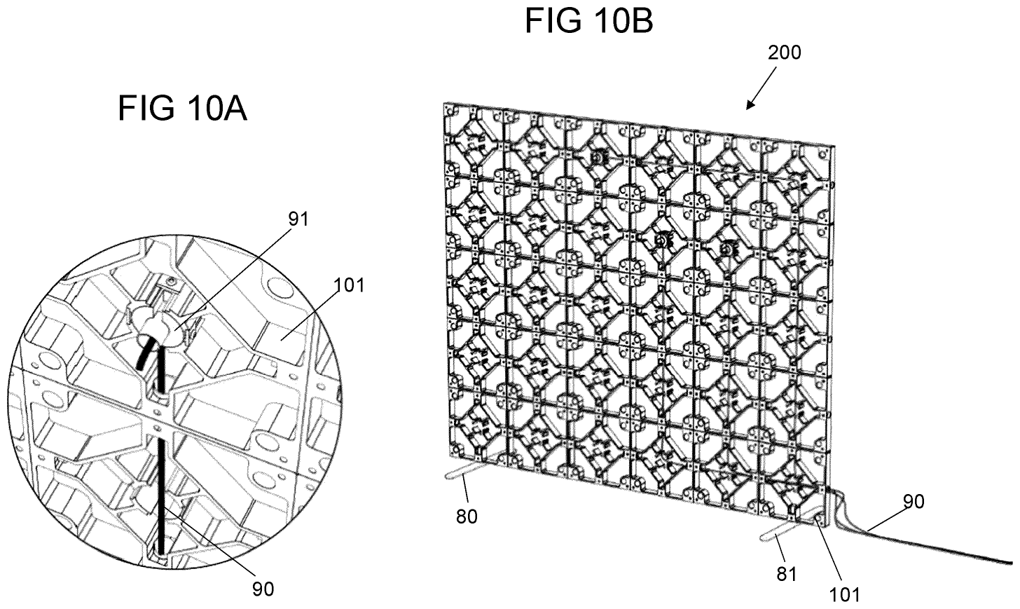

FIG. 10 (A) illustrates an embodiment of the construction frame comprising a receptacle piece which serves as outlet for a cable and (B) illustrates a system according to the invention with cables and pipes;

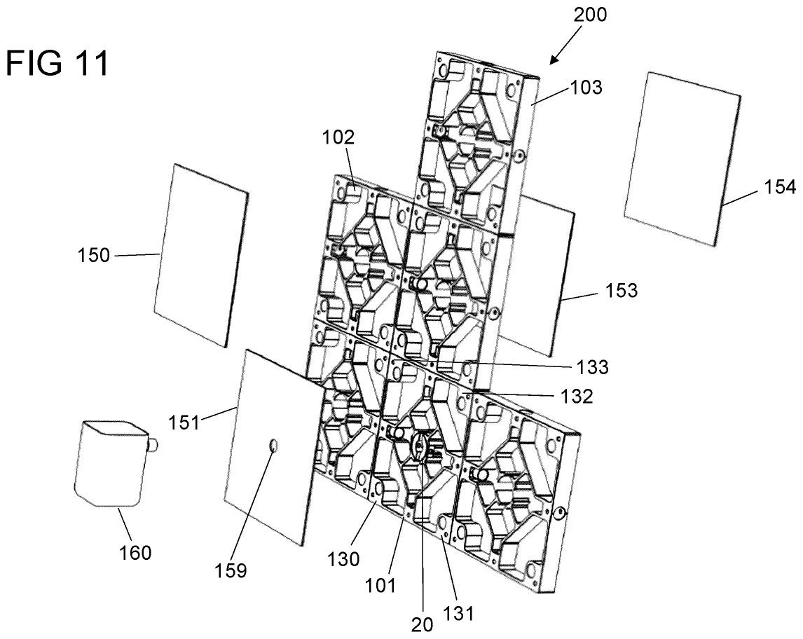

FIG. 11 illustrates an embodiment of the invention with decorative panels and an accessory;

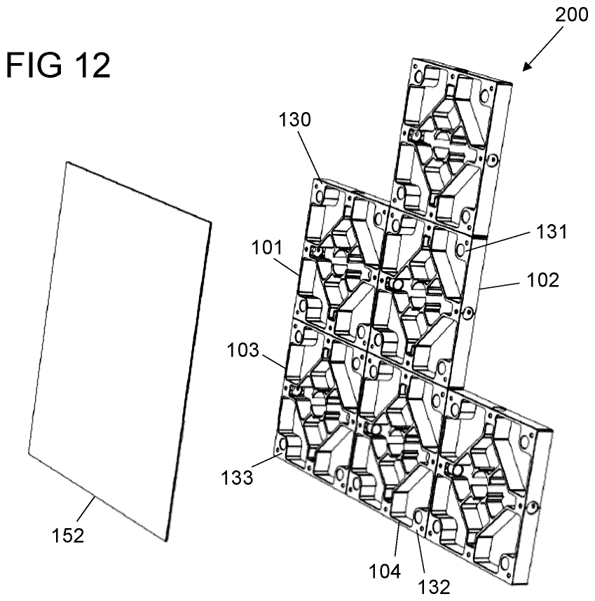

FIG. 12 illustrates an embodiment of the system of the invention with a decorative panel, which covers more than one construction frame;

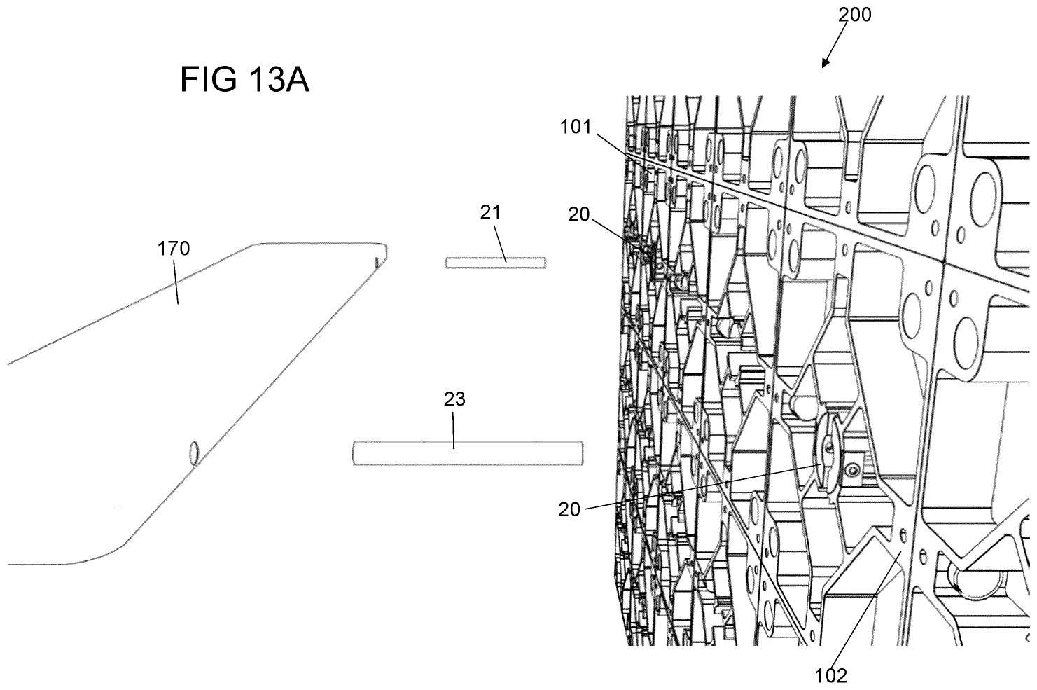

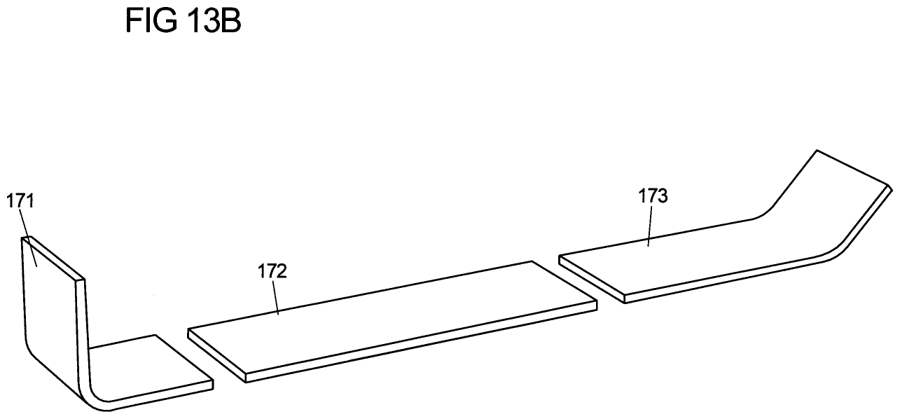

FIG. 13 (A) illustrates a system of the invention with a functional element and (B) illustrates functional elements;

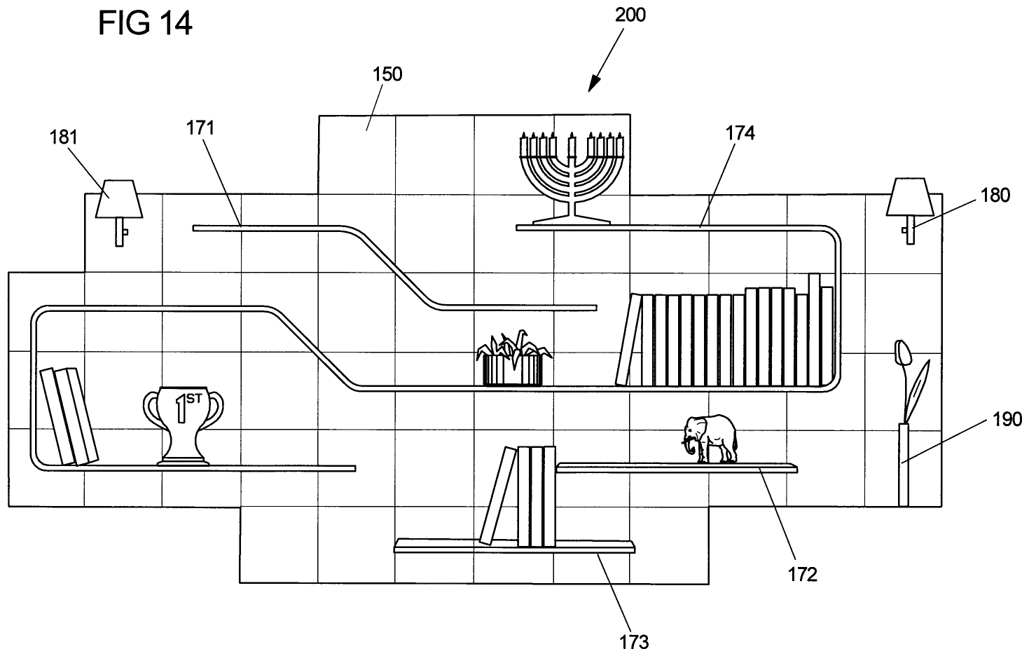

FIG. 14 illustrates a system of the invention comprising different functional elements;

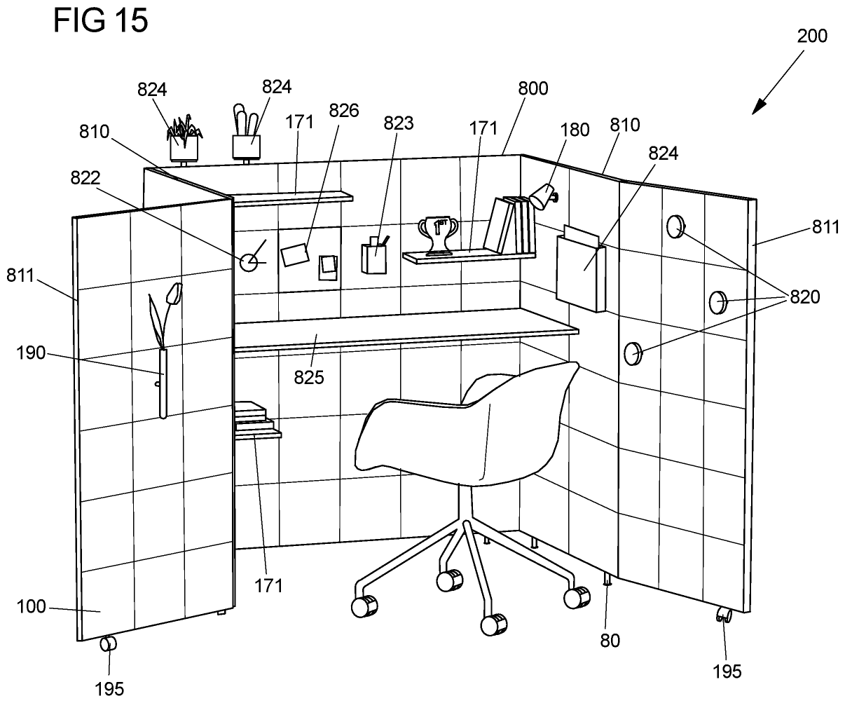

FIG. 15 illustrates a system of the invention being an individual office;

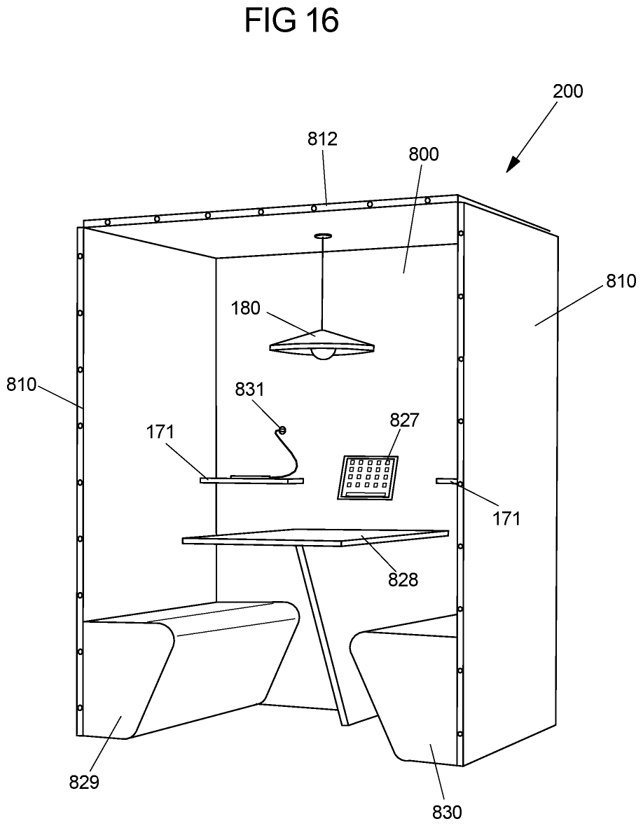

FIG. 16 illustrates a system of the invention being a meeting room;

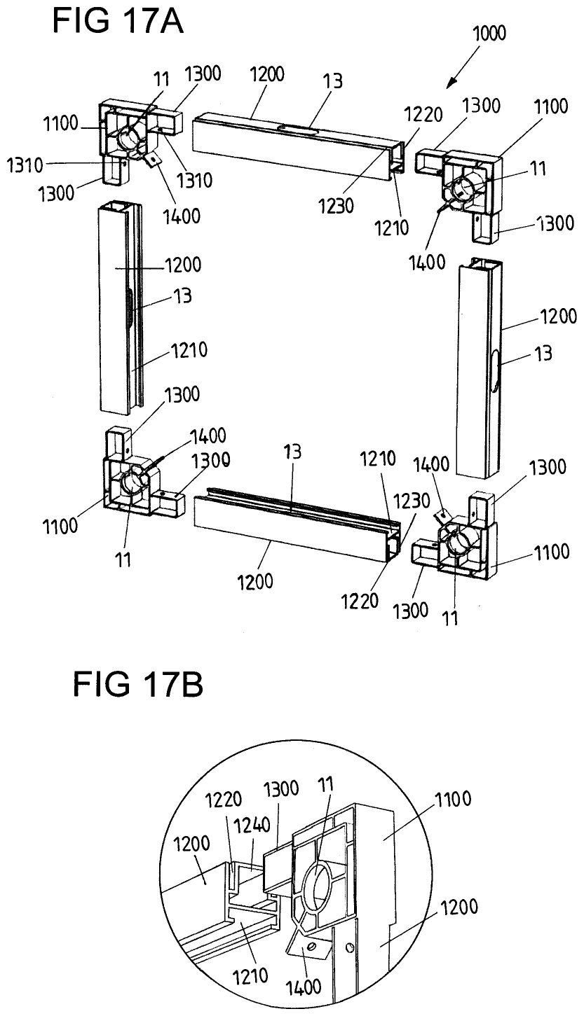

FIGS. 17 (A) and (B) illustrate an embodiment of the invention with detachable angle pieces and lateral connector pieces;

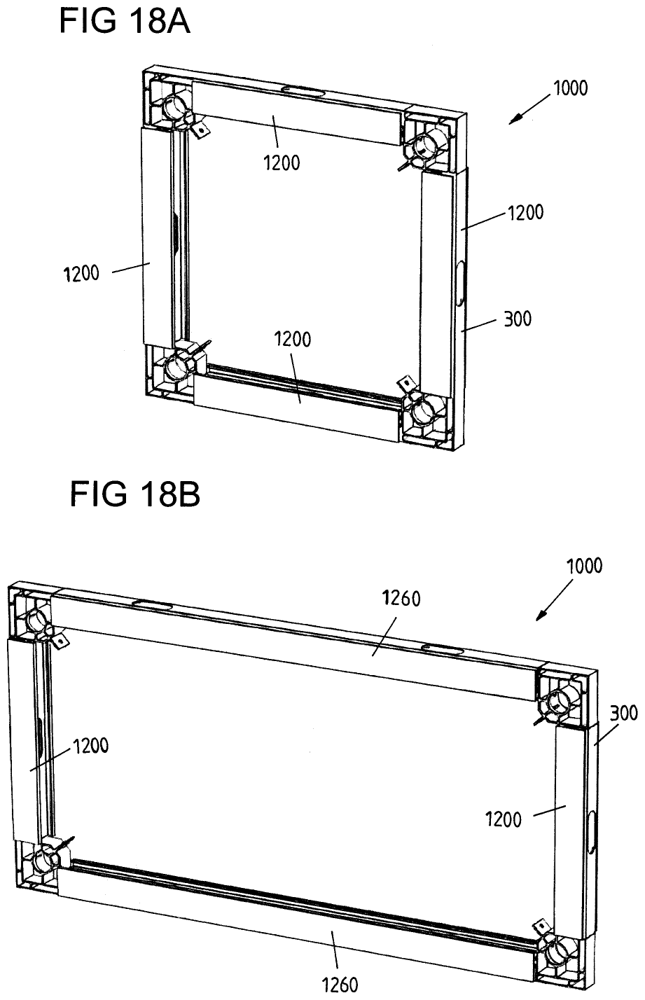

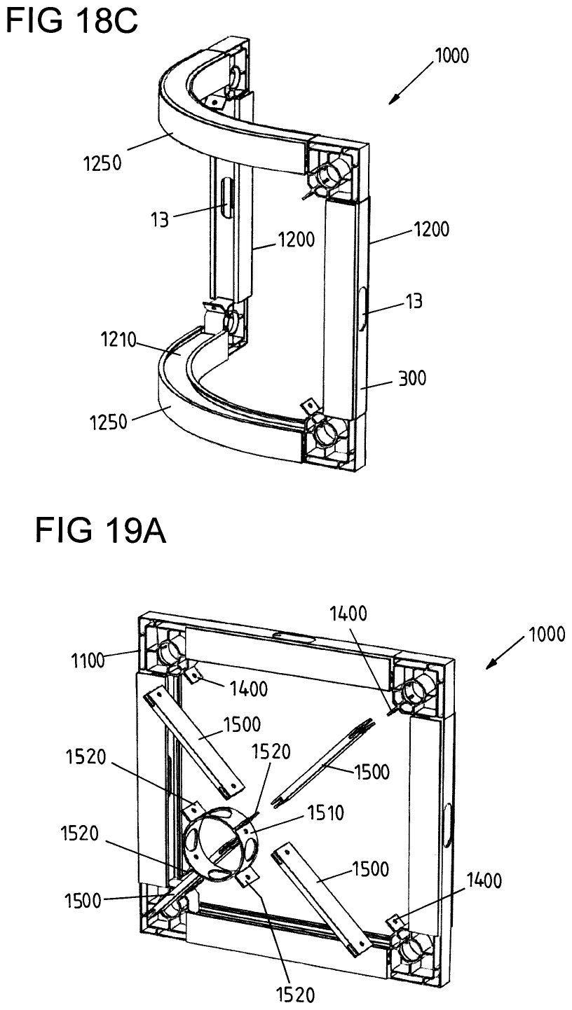

FIGS. 18 (A) to (C) illustrate different outer geometrical shapes of the construction frame according to the invention;

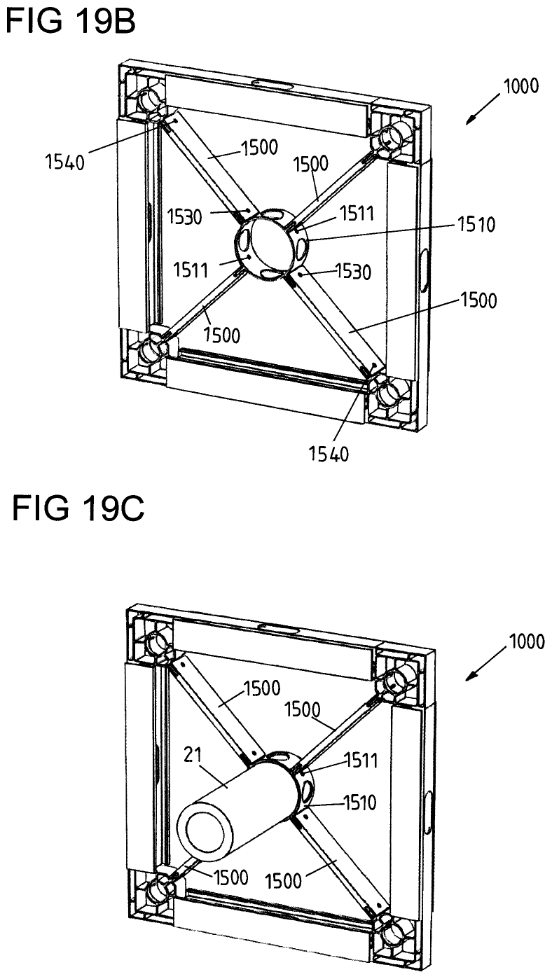

FIGS. 19 (A) to (C) illustrate embodiments of the construction frame with detachable inner structures;

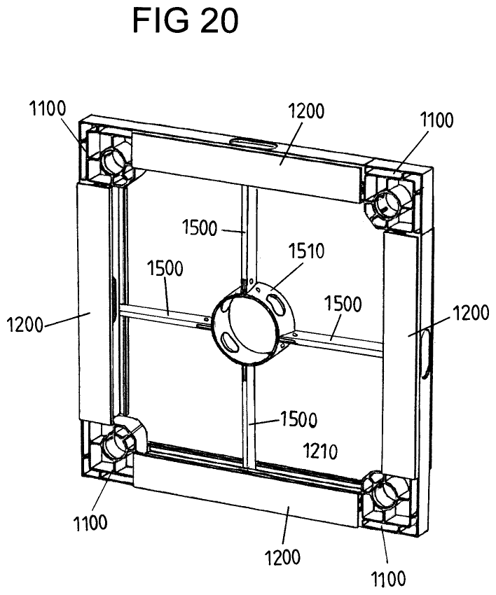

FIG. 20 illustrates a further embodiment of the construction frame with a detachable inner structure;

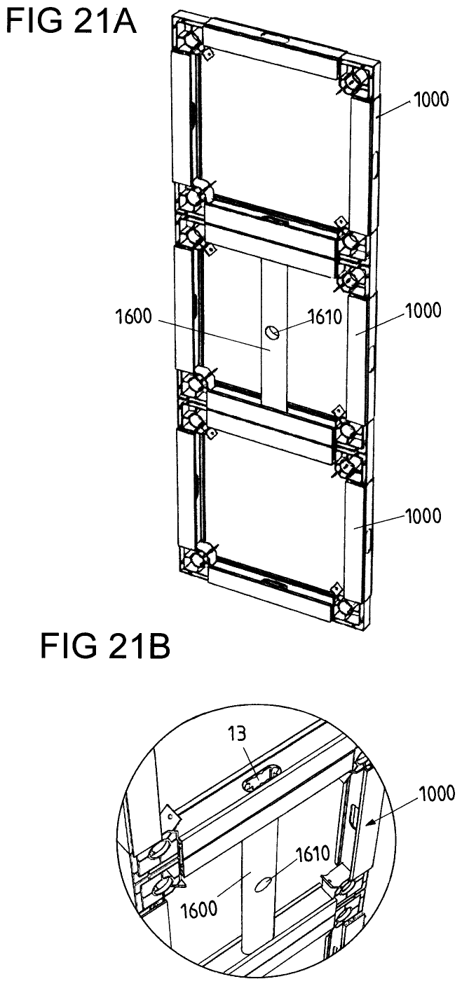

FIGS. 21 (A) and (B) illustrate construction frames with a connecting strip;

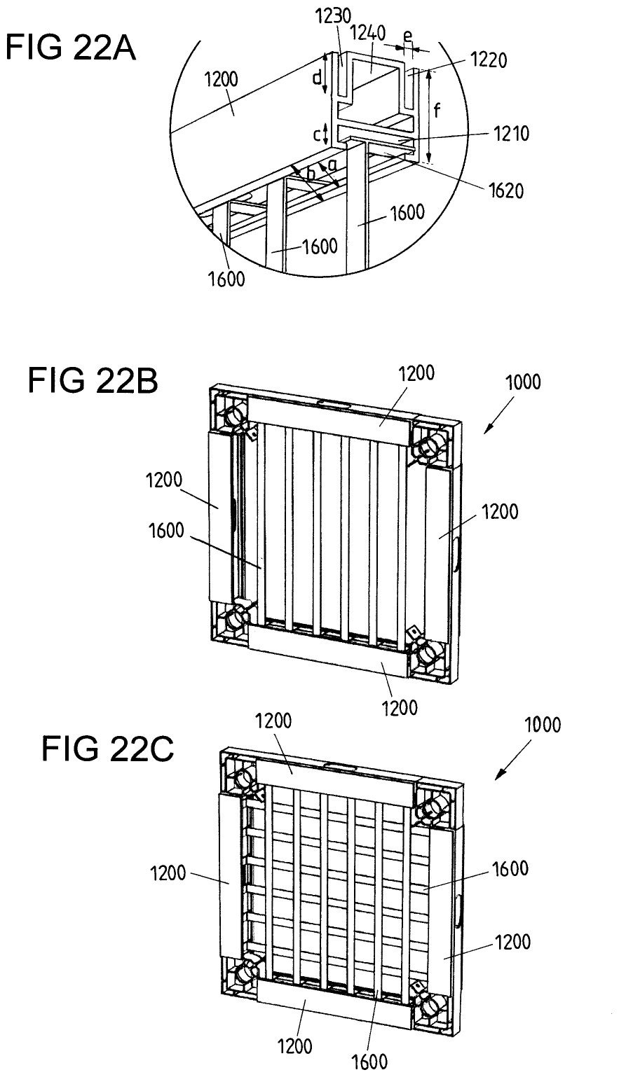

FIGS. 22 (A) to (C) illustrate further construction frames according to the invention with multiple connecting strips;

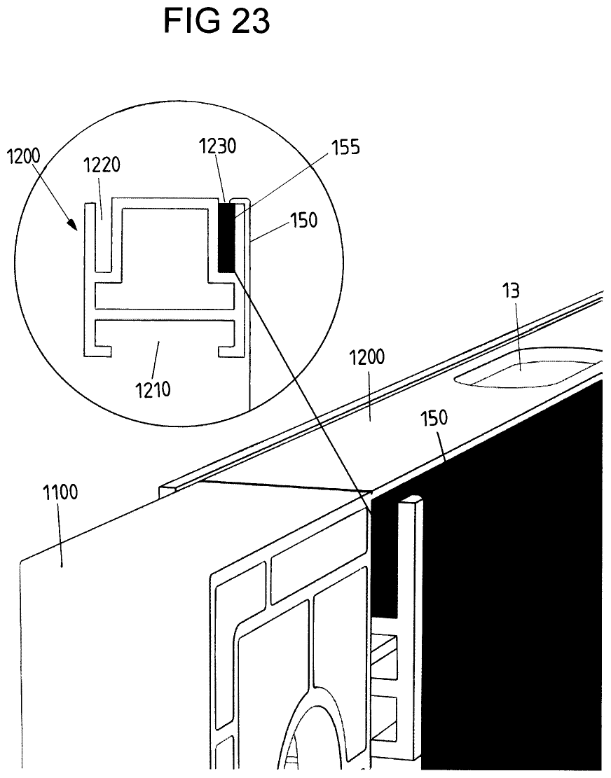

FIG. 23 illustrates a construction frame with a decorative panel, which is hooked in a second elongated receiving opening.

FIG. 1A illustrates an embodiment of the construction frame 100, wherein the outer side 300 has a square geometrical shape. The inner structure 400 comprises the central hole 10 and four screw holes 12a. Furthermore, the inner structure 400 adjoins once on each side of the square. At each of these points of contact, the side part 300 has a receptacle 13, which is shown in FIG. 1B. The outer side 300 further comprises four corner through holes 11 and four screw holes 12b, wherein one corner through hole 11 and one screw hole 12b are located in each of the corner of the side part 300.

A pivot 21 can be inserted in the central hole 10 by a receptacle piece 20, which is illustrated in FIGS. 2A to 2C. The receptacle piece 20 is inserted in the central hole 10 of the construction frame 100, wherein the receptacle piece 20 is suited to recept the pivot 21. Pivot 21 and receptacle piece 20 are fixed by pairs of screws 26 and washer 25 and 27, 28. The pivot 21 protrudes from the front side of the construction frame 100. FIG. 2C illustrates a construction frame 100, comprising a pivot 22 which protrudes from the front side and from the back side of the construction frame 100.

FIG. 3A illustrates a construction frame 100 with a receptacle piece 20, a pivot 21 and different connectors. Illustrated is a straight connector 30, a 90° connector 40, a 45° connector 50 and a hinge connector 60. FIG. 3B illustrates the angle α which is enclosed by the two straight parts of the angle connector 500 and the supplementary angle β. All connectors comprise two screw holes in their straight part, which are suited to fix the connectors in the receptacle 13 of a construction frame 100 with a screw through a screw hole 12a.

FIGS. 4A and 4B illustrate the connection of several construction frames 101-105 by straight connectors 30-35. A system 200 according to the invention is build up.

FIG. 5 illustrates a system 200 according to the invention. The construction frames 101, 102, 103 and 104 are connected by straight connectors as well as the construction frames 105, 106, 107 and 108. Subsequently, the construction frames 102 and 105 are connected by a 45° connector 50, 51 as well as construction frame 104 and 107. In this way for example a paravent can be build up.

FIGS. 6A and 6B illustrate a system 200 which could be a part of a box. Construction frames 11, 102,103 and 104 are connected by straight connectors, the same is done with construction frames 109, 110, 111, 112 and with construction frames 105, 106, 107, 108. Afterwards, construction frames 101 and 112 are connected by 90° connector 40, construction frames 104 and 109 are connected by 90° connector 41, construction frames 104 and 107 are connected by 90° connector 42, construction frames 103 and 105 are connected by 90° connector 43, construction frames 107 and 109 are connected by 90° connector 44, construction frames 108 and 110 are connected by 90° connector 45. FIG. 6B shows the complete system 200.

FIG. 7 illustrates a further system 200 according to the invention. The construction frames 101, 102, 103 and 104 are connected by straight connectors as well as the construction frames 105, 106, 107 and 108. Subsequently, the construction frames 101 and 105 are connected by a hinge connector 60, 61 as well as construction frame 104 and 107. Accordingly, the system 200 comprises two wall like elements movable in relation to each other.

FIG. 8A illustrates a mounting system which is suited to a fix a system 200 according to the invention. The mounting system comprises a locking device 71 which is suited to be inserted in a receptacle and a locking pin 70 which can be for example fixed to a wall. The locking device 71 is attached to the system 200 by a screw 72 through the screw hole 12b as can be seen in FIG. 8B. System 200 is a wall element which can be fixed for example to a room wall by the described mounting system, wherein a mounting system is attached to the construction frames 101, 102, 103 and 104.

FIG. 9A illustrates a construction frame 101 with a stand 80, wherein the stand 80 is attached to the receptacle 13. FIG. 9B illustrates a system 200, which can function as a free standing wall. A stand 80, 81 is attached to each construction frame 101, 102, which enables system 200 to stand freely.

In a further embodiment of the invention the construction frame 101 comprises a receptacle piece 91 which can serve as an outlet for a cable and/or a pipe 90 as illustrated in FIG. 10A. Advantageously, cable and/or pipes can enter the system 200 through a receptacle 13 of a construction frame 101 (FIG. 10B). The cables and/or pipes 90 a routed inside the system from one construction frame to another by entering and leaving the several construction frames through the receptacles 13. Therefore, it is most preferable that the connectors which connect different construction frames are hollow, to enable cables and/or pipes to run through them. Cables and/or pipes can be routed to every desired point in the system 200 and can according to the invention leave the system through a receptacle piece 91 which functions as an outlet.

FIG. 11 illustrates an embodiment of the system 200 with decorative panels 150, 151, 153, 154 and an accessory 160. Decorative panels 150 is attached to the front side of the construction frame 102 and decorative panel 153 is attached to the backside of the construction frame 102. Further, decorative panel 154 is attached to the backside of the construction frame 103. Decorative panel 151 comprises a perforation 159 which is suited to attach an accessory 160 through the perforation inside the receptacle piece 20 of construction frame 101 after the decorative panel 151 has been attached to the construction frame 101. The accessory 160 could be for example a penholder. In this embodiment of the invention decorative panels 105, 151, 153, 154 have the same size as the construction frames 101, 102, 103, whereby one decorative panel covers one construction frame. Due to the features of the invention it is possible to cover both sides of the construction frames by panels and it is possible to attach accessories and/or functional elements on both side of the system according to the invention if desired. In this embodiment of the system the decorative panels 150, 151, 153, 154 are attached to the construction frames 101, 102, 103 by magnetic parts 130, 131, 132, 133, which are comprised in each construction frame 101, 102, 103. Decorative panels 105, 151, 153, 154 comprise corresponding magnetic counterparts.

FIG. 12 illustrates a system 200 according to the invention, wherein the system 200 comprises the construction frames 101, 102, 103, 104. A decorative panel 152 is attached to these construction frames, wherein the decorative panel 152 has such a size that all four construction frames 101, 102, 103, 104 are covered by the decorative plate 152. The decorative plate 152 is attached to the construction frames via magnetic parts 130, 131, 132, 133 which are comprised in the construction frames 101, 102, 103, 104.

FIG. 13A illustrates a system 200 with a functional element 170, wherein the functional element is a book shelf. The functional element 170 is attached to the construction frames 101 and 102 by the pivots 21, 23 which are inserted in the receptacle pieces 20. In this way, it is possible to attach functional elements 170 of different forms and sizes to a system 200 according to the invention. FIG. 13B illustrates examples of different forms of book shelfs 171-173 which are attachable to a system 200 according to the invention. All book shelfs can be combined with each other as required.

FIG. 14 illustrates a system 200 according to the invention. The system 200 is a shelf wall comprising decorative panels 150 and several book shelfs 171, 172, 173 and 174. Additionally, lamps 180, 181 as functional elements and a vase 190 as accessory are attached.

FIG. 15 illustrates a system 200 according to the invention being an individual office. The office is build up by walls serving as back wall 800, two side walls 810 and two doors 811, wherein the doors are connected to the side part with hinge connectors. The walls are build up by construction frames 100 according to the invention. All construction frames are covered with decorative panels from the front and from the backside. Inside the office a desk 825 is attached as well as several shelfs 171, a pencil holder 823, a clock 822, a storage tray 821 and a lamp 180. To enhance comfort the doors 811 comprise several hanging options 820 for e.g. jackets and a vase 190. The back wall 800 further comprises two flower pots 824. Due to the casters 195 attached to doors 811 the office can be closed if not needed, therefore the individual office is particularly suitable for home office purposes. Back wall 800 and the two side walls 810 comprise several stands 80.

The size and interior design (e.g. which and how many functional elements and/or accessories are attached) of the individual office depends entirely on the wishes and needs of the customer. Due to the modular concept of the system according to the invention almost all needs can be met.

FIG. 16 illustrates a system 200 according to the invention being a meeting or a dining room. The room comprises a back wall 800, a ceiling 812, and two side walls 810. The back wall 800, the ceiling 812 and the two side walls 810 are covered by decorative panels, which have accordingly the dimensions of the back wall, the side walls and the ceiling. The room comprises two seats 829, 830 and a table 828. Further, a lamp 180, a power outlet 831, shelfs 171, a screen 827 as functional elements and accessories are attached.

FIGS. 17 (A) and (B) illustrate an embodiment 1000 of the invention with detachable angle pieces 1100 and lateral connector pieces 1200. The angle pieces 1100 comprise two extensions 1300 which can each be plugged into a lateral connector piece 1200. Each extension 1300 of an angle piece 1100 comprises a hole for a screw 1310. The lateral connector piece 1200 comprises corresponding holes, so that each angle piece 1100 can be plugged into a lateral connector piece 1200 and can be fixed by a screw.

FIG. 17 (B) illustrates how the angle piece 1100 can be plugged into the part 1240 of a lateral connector piece 1200. The figure further illustrates two of the three elongated receiving openings of the lateral connector piece 1200. The first elongated receiving opening 1210 is positioned on a first side of the lateral connector piece 1200 and the second elongated receiving opening 1220 is positioned on a second side of the lateral connector piece 1200. All three elongated receiving openings 1210, 1220, 1230 are formed over the entire length of the lateral connector piece 1200. The first sides of the at least four lateral connector pieces 1200 comprised in the construction frame 1000 are all directed to the inside of the frame, as can be seen in FIG. 17 (A).

FIGS. 18 (A) to (C) illustrate different outer geometrical shapes of the construction frame 1000 according to the invention. FIG. 18 (A) illustrates a square shaped construction frame 1000, FIG. 18 (B) illustrates a rectangular shape of a construction frame 1000 and FIG. 18 (C) illustrates a construction frame 1000 with two curved lateral connector pieces 1250 and two straight lateral connector pieces 1200.

FIGS. 19 (A) to (C) illustrate embodiments of the construction frame 1000 with detachable inner structures. The inner structure comprises at least one connecting piece 1500, preferably the inner structure comprises four connecting pieces 1500. Each connecting piece 1500 is connected to one angle piece 1100 of the construction frame 1000. The angle piece 1100 comprises in this embodiment a further extension 1400, which can be pushed into a connector piece 1500 and which can be fixed by a suitable hole-screw combination 1540. Further, the inner structure comprises a central hole, which is formed in this embodiment by the round receptacle 1510. The round receptacle 1510 comprises four extension 1520 which can each be pushed in connecting pieces 1500, respectively. Further, the round receptacle 1510 is connected to the connecting pieces by at least one screw. Therefore, the round receptacle and the at least one connector piece comprise suitable holes 1530.

FIG. 19 (C) illustrates a construction frame 1000 with an inner structure comprising a pivot 21. The pivot 21 is inserted in the central hole directly without utilizing a receptacle piece. In this case the central hole is build by a round receptacle 1510, wherein the round receptacle 1510 and the pivot are fixed by more than one fixing means, such as more than one pair of washer and screw, preferably by two to four pairs of washer and screw. Any other fixing means, which fulfill the same function as the pairs of washer and screw are also encompassed by the invention. The round receptacle 1510 comprises respective holes 1511.

FIG. 20 illustrates a further embodiment of the construction frame 1000 with a detachable inner structure. In this embodiment each connecting piece is pushed into the first elongated receiving opening of a lateral connector piece 1200. The position of the central hole formed by the round receptacle 1510 is fixed if at least two connector pieces 1500 connect the round receptacle 1510 to two neighbored lateral connector pieces 1200.

FIGS. 21 (A) and (B) illustrate a construction frame 1000 with a connecting strip 1600. The connecting strip 1600 is attached to the construction frame via the receptacle 13. Further, the connecting strip 1600 comprises a receptacle 1610 which is suited to receive a pivot 21 according to the invention.

FIGS. 22 (A) to (C) illustrate further construction frames 1000 according to the invention with multiple connecting strips 1600. The connecting strips 1600 are pushed into the first elongated receiving opening 1210 of the lateral connector piece 1200, as illustrated in FIG. 22 (A). Therefore, the connecting strips 1600 comprise in this embodiment an extension 1620, so that the connecting strip 1600 can be pushed in the first elongated receiving opening 1210 and can slight inside the first elongated receiving opening 1210. According to the invention connecting strips 1600 can be arranged in the direction of lateral connector pieces 1200 opposing each other. Thus FIG. 22 (B) illustrates a square shaped construction frame 1000 with vertical connecting strips 1600 and FIG. 22 (C) illustrates a square shaped construction frame 1000 with vertical connecting strips 1600 and horizontal connecting strips 1600. In both figures each connector strip 1600 is pushes in two lateral connector pieces 1200, wherein the two lateral connector strips 1600 oppose each other.

FIG. 23 illustrates a construction frame 1000 with a decorative panel 150, which is hooked in a second elongated receiving opening 1230 of a lateral connector piece 1200. The decorative panel 150 comprises an extension 155 which enables that the decorative panel 150 is hooked or pushed in the second or third elongated receiving opening 1230, 1220. As can be seen the thickness in longitudinal direction of the angle pieces 1100 is smaller compared to the thickness of the lateral connector pieces 1200 in longitudinal direction. According to the invention the two grooves forming the second 1230 and the third 1220 elongated receiving opening exceed the thickness of the angle pieces 1100 on the respective side of the lateral connector piece 1200.

### Example 1

A system being a freestanding wall was build up by 8×6 construction frames which were connected by straight connectors, wherein each construction frames had a size of 20 cm×20 cm. On the front side 3×3 construction frames were covered by one decorative panel with a whiteboard surface. Additionally, one construction frame was covered by a decorative panel with a perforation which enables the attachment of a pencil holder e.g. for whiteboard markers.

One construction frame was covered by a decorative panel comprising a watch as functional element. Furthermore, power cables entered the system through a receptacle of a construction frame and were routed to a construction frame which comprised a decorative panel with a perforation and a receptacle piece which functions as power outlet. Below the power outlet, three construction frames were covered by three decorative panels, wherein two of the decorative panels comprised perforations which enable the attachment of a book shelf. In the left corner of the freestanding wall a screen was attached to a construction frame. All further construction frames were covered by decorative panels. All decorative panels, except of the decorative panels with the whiteboard surface, had a surface in wood optics and were attached by magnetic parts comprised in the construction frames and in the decorative panels. Further two stands each with two casts were attached to the freestanding wall, wherein the stands were attached to two receptacles of the system. The whole backside was covered by decorative panels having the same size as the construction frames.

### Example 2

Basically a freestanding wall as described in example 1 was build up. Additionally the same combination of decorative panels, functional elements and accessories as attached to the front side was attached to the back side.

### Example 3

A system being an individual office was build up. One back wall was build up by 6×6 construction frames, which had a size of 20 cm×20 cm and which were connected by straight connectors. Two side walls were build up, each by 2×6 construction frames which had a size of 20 cm×20 cm and which were connected by straight connectors. The back wall was connected with 90° connectors on the left and on the right side with a side wall. The back wall and the two side walls comprised stands.

Further a first and a second further wall was build up, each by 3×6 construction frames, which had a size of 20 cm×20 cm and which were connected by straight connectors. The first further wall was connected with hinge connectors to one side wall and the second further wall was connected with hinge connectors to the other side wall. The first and the second further wall comprised each a caster and serve as doors for the individual office. All walls were covered from both sides by decorative panels, which had the same size as the construction frames.

Inside the office box which was build up by the walls a desk was attached to the back wall and the side walls, additional functional elements like shelfs, screens, power supply, lamps and pencil holders were attached.

Such a design of an individual office is especially advantageously for home office purposes.

### Example 4

A system being a wall cladding for a kitchen was build up by connecting 14×4 construction frames with straight connector. Each construction frame had a size of 20 cm×20 cm. The wall cladding was mounted to the kitchen wall by a wall mounting system and a decorative panel with a size of 80 cm×80 cm with marble decor was attached above the region of the wash basin. All other construction frames were covered by decorative panels in the size of the construction frames. Additionally, a lamp, two shelfs and a support bar for kitchen accessories was attached.

### Example 5

A system being a freestanding outdoor wall was build up by connecting 4×5 construction frames with straight connectors. Each construction frame had a size of 20 cm×20 cm. The outdoor wall was covered from both sides with decorative panels made of plastic which had the same size as the construction frames. Additionally, a water pipe entered the wall through a receptacle and was routed inside the outdoor wall to two water outlets which were attached to two decorative panels. On top of the outdoor wall a parasol was attached to a receptacle of one construction frame.

### Example 6

A construction frame comprising four straight lateral connector pieces, having equal dimensions, wherein the four lateral connector pieces are connected to each other by four angle pieces. The lateral connector pieces have the following dimensions, reference signa are illustrated in FIG. 22 (A).

| | |
|---|---|
| a | 26 mm |
| b | 30 mm |
| c | 10 mm |
| d | 13 mm |
| e | 3 mm |
| f | 35 mm |

### LIST OF REFERENCE NUMBERS

10 central hole
11 corner through hole
12a, 12b screw hole
13 receptacle
20, 91 receptacle piece
21, 22, 23 pivot
washer
26, 72 screw
27 screw and washer
30-35 straight connector
40-45 90° connector
50, 51 45° connector
60, 61 hinge connector
70 locking pin
71 locking device
80, 81 stand
90 cable, pipe
100-112 construction frame
130-133 magnetic parts
150-154 decorative panel
159 perforation
160 accessory
170 functional element
171-174 book shelf
180, 181 lamps
190 vase
195 caster
200 system
300 side part
400 inner structure
500 angle connector
600 cross direction
700 longitudinal direction
800 back wall
810 side wall
811 door
812 ceiling
820 hanging options
821 storage tray
822 clock
823 pencil holder
824 flower pot
825 desk
826 pinboard
827 screen
828 table
829, 830 seat
831 power outlet
1000 construction frame
1100 angle piece
1200, 1260, 1250 lateral connector piece
1210 first elongated receiving opening
1220 second elongated receiving opening
1230 third elongated receiving opening
1240 part of lateral connector piece
1300, 1400 extension
1500 connecting piece
1510 round receptacle
1511 hole
1520 extension
1530 hole
1540 hole
1600 connecting strip
1610 receptacle

1. A construction frame comprising:
a front side;
a back side;
a side part;
at least four angle pieces;
at least four lateral connector pieces, wherein each lateral connector piece connects at least two angle pieces; and
at least one receptacle in the side part.

2. The construction frame according to claim 1, wherein:
the four angle pieces and the lateral connector pieces are formed in one piece or the at least four angle pieces, and the at least four lateral connector pieces of the construction frame are detachably connected with each other.

3. The construction frame according to claim 1, wherein the lateral connector piece comprises three elongated receiving openings.

4. The construction frame according to claim 1, further comprising:
an inner structure with a central hole; and
at least one receptacle in the side part.

5. The construction frame according to claim 1, wherein:
the inner structure is formed in one piece together with the front side, the back side and the side part; or
the inner structure is detachable connected to at least one angle piece.

6. The construction frame according claim 1, further comprising one corner through hole in each corner, wherein the corner through hole extends in longitudinal direction.

7. The construction frame according to claim 1, further comprising n screw holes, wherein n is an integer between 1 and 20.

8. The construction frame according to claim 1, further comprising at least one magnetic part.

9. The construction frame according to claim 1, further comprising at least one pivot and a receptacle piece, wherein the at least pivot is inserted in the central hole through the receptacle piece.

10. The construction frame according to claim 1, further comprising at least one cable and/or at least one pipe.

11. The construction frame according to claim 1, further comprising at least one decorative panel or at least one connecting strip.

12. The construction frame according to claim 1, further comprising at least one stand and/or at least one caster.

13. The construction frame according to claim 1, further comprising at least one functional element and/or at least one accessory.

14. The construction frame according to claim 1, wherein the lateral connector pieces are straight or curved.

15. A system comprising at least one construction frame according to claim 1.

16. The system according to claim 15, comprising at least two construction frames, wherein said at least two construction frames are connected by at least one connector which is inserted in the at least one receptacle of each construction frame.

17. The system according to claim 15, wherein the connector is selected from the group consisting of straight connectors, angle connectors, 90° connectors, 45° connectors and hinge connectors.

18. The system according to claim 15, further comprising at least one decorative panel.

19. The system according to claim 15, further comprising at least one functional element and/or at least one accessory.

20. The system according to claim 15, wherein said system is selected from the group consisting of a wall, a box, wall shelf, a wall covering, a ceiling covering, a floor covering, and a piece of furniture.

21.-22. (canceled)
